(19) United States
(12) Patent Application Publication
(10) Pub. No.: US 2006/0204818 A1
(43) Pub. Date: Sep. 14, 2006

(54) Transition metal nitride and fuel cell applications

(75) Inventors: Nobutaka Chiba, Yokohama-shi (JP); Noriko Uchiyama, Miura-shi (JP); Makoto Kano, Yokohama-shi (JP)

Correspondence Address: SHUMAKER & SIEFFERT, P. A., 8425 SEASONS PARKWAY, SUITE 105, ST. PAUL, MN, 55125, US

(73) Assignee: Nissan Motor Co., Ltd., Yokohama-shi (JP)

(21) Appl. No.: 11/360,010

(22) Filed: Feb. 22, 2006

(30) Foreign Application Priority Data
Feb. 22, 2005 (JP) 2005-045751
Feb. 22, 2005 (JP) 2005-045689
Jun. 30, 2005 (JP) 2005-191590

(51) Int. Cl. H01M 8/02; B32B 15/04; B05D 5/12; C01B 21/00

(52) U.S. Cl. 429/34; 428/457; 427/115; 427/126.1; 423/351

(57) ABSTRACT

The disclosure relates to transition metal nitrides having a chemical formula (Fe_{100-x-y-z}CrₓNi_{y}Mo_{z})₄N_{w}, wherein 0.8≦w≦1.7, 19≦x≦30, 11≦y≦19, and 0≦z≦3. The disclosure also relates to fuel cell bipolar plates, fuel cells, fuel cell assemblies, and fuel cell powered vehicles including the transition metal nitride, and methods of manufacturing fuel cell bipolar plates using plasma nitriding.

This application claims priority from Japanese Patent Application No. 2005-045751, filed Feb. 22, 2005; Japanese Patent Application No. 2005-045689, filed Feb. 22, 2005; and Japanese Patent Application No. 2005-191590, filed Jun. 30, 2005; and the entire contents of each are incorporated herein by reference.

### TECHNICAL FIELD

The invention relates to transition metal compounds, particularly transition metal nitrides. The invention also relates to fuel cells and methods of manufacturing fuel cells.

### BACKGROUND

In forming a fuel cell assembly from individual unit fuel cells, it is usually necessary to provide an electrically conductive layer, generally referred to as a fuel cell bipolar plate, between a cathode face of one unit fuel cell and an anode face of an adjoining unit fuel cell, thereby electrically connecting each unit fuel cell in series to a common power output bus. The bipolar plate, which may have channels formed in the surfaces contacting the anode and cathode, also may serve as a means of feeding oxygen to the cathode and fuel gas to the anode.

### SUMMARY

It is desirable to provide a low cost, electrically conductive fuel cell bipolar plate made from a corrosion resistant bipolar plate material that maintains a low contact resistance between the bipolar plate and the unit fuel cell electrodes. In general, the invention relates to a transition metal nitride that may be used, for example, in a bipolar plate of a fuel cell. For example, when the transition metal nitride is applied on a stainless steel substrate to form a bipolar plate, the bipolar plate has low contact resistance and excellent resistance to corrosion.

In one embodiment, a chemical composition includes a transition metal nitride having a formula (Fe_{100-x-y-z}, CrₓNi_{y}Mo_{z})₄N_{w}, wherein 0.8≦w≦1.7, 19≦x≦30, 11≦y≦19, and 0≦z≦3. In certain embodiments, 0.8≦w≦1, 19≦x≦27, 11≦y≦15, and 0≦z≦3. In other embodiments, 0.8≦w≦1.7, 25≦x≦27, 13≦y≦19, and 0≦z≦1.

In another embodiment, the transition metal nitride may be characterized by the relationship 5.9≦{0.01[6(atomic percent Fe)+5(atomic weight percent Cr)+8(atomic weight percent Ni)+5 (atomic weight percent Mo)]}≦6.1. In some embodiments, the transition metal nitride exhibits an atomic ratio of transition metal atoms to nitrogen atoms of from about 4:0.8 to about 4:1.

In other embodiments, a bipolar plate for a fuel cell is provided, the bipolar plate comprising a base layer formed of a stainless steel comprising Fe as a major component, Cr, and at least one element selected from Ni or Mo. A transition metal nitride overlays the base layer, the nitride layer having an empirical formula M₄N_{Y}, in which M is selected from the group consisting of Fe, Cr, Ni, Mo and combinations thereof, N is nitrogen, and Y is from about 0.8 to about 1.7. In certain exemplary embodiments, the transition metal nitride has the formula (Fe_{100-x-y-z}CrₓNi_{y}Mo_{z})₄N_{w}, wherein 0.8≦w≦1.7, 19≦x≦30, 11≦y≦19, and 0≦z≦3. In certain exemplary embodiments, 0.8≦w≦1, 19≦x≦27, 11≦y≦15, and 0≦z≦3. In other exemplary embodiments, 0.8≦w≦1.7, 25≦x≦27, 13≦y≦19, and 0≦z≦1. In additional exemplary embodiments, the transition metal nitride is characterized by the relationship 5.9≦{0.01[6(atomic percent Fe)+5(atomic weight percent Cr)+8(atomic weight percent Ni)+5 (atomic weight percent Mo)]}≦6.1.

In further embodiments, a fuel cell assembly is provided, the fuel cell assembly including a plurality of unit fuel cells arranged in a stack, with each unit fuel cell separated by a bipolar plate. The bipolar plate comprises a base layer formed of a stainless steel comprising Fe as a major component, Cr, and at least one element selected from Ni or Mo; and an overlayer comprising a transition metal nitride. In some exemplary embodiments, the transition metal nitride has an empirical formula M₄N_{w}, in which M is selected from the group consisting of Fe, Cr, Ni, Mo and combinations thereof, N is nitrogen, and w is from about 0.8 to about 1.7. In other exemplary embodiments, w is from about 0.8 to about 1.0.

In additional embodiments, a vehicle includes a fuel cell assembly with a plurality of unit fuel cells arranged in a stack, with each unit fuel cell is separated by a bipolar plate. In certain embodiments, the bipolar plate comprises a base layer formed of a stainless steel comprising Fe as a major component, Cr, and at least one element selected from Ni or Mo; and a transition metal nitride overlayer. The transition metal nitride has an empirical formula M₄N_{w}, wherein M is selected from the group consisting of Fe, Cr, Ni, Mo and combinations thereof, N is nitrogen, and w is from about 0.8 to about 1.7. In other exemplary embodiments, w is from about 0.8 to about 1.0.

In other embodiments, a method of manufacturing a fuel cell bipolar plate is provided. The method includes the steps of forming a nitrided layer on a surface of a stainless steel material including Fe as a major component, Cr, and at least one element selected from Ni or Mo. In certain embodiments, the nitrided layer comprises a transition metal nitride having an empirical formula M₄N_{w}, in which M is selected from the group consisting of Fe, Cr, Ni, Mo and combinations thereof, and N is a nitrogen atom. In certain exemplary embodiments, the transition metal nitride has a chemical formula (Fe_{100-x-y-z}CrₓNi_{y}Mo_{z})₄N_{w}, wherein 0.8≦w≦1.7, 19≦x≦30, 11≦y≦19, and 0≦z≦3. In certain embodiments, 0.8≦w≦1, 19≦x≦27, 11≦y≦15, and 0≦z≦3. In other embodiments, 0.8≦w≦1.7, 25≦x≦27, 13≦y≦19, and 0≦z≦1.

In certain exemplary embodiments, the nitrided layer is formed by plasma nitriding. In some exemplary embodiments, plasma nitriding includes applying a negative bias voltage to said stainless steel material in a non-equilibrium plasma formed by passing an electrical discharge through a mixture of nitrogen gas and hydrogen gas at a temperature of about 400° C. to about 500° C. In other embodiments, the disclosure provides a bipolar plate for a fuel cell produced according to the method described above.

According to some embodiments of the invention, a transition metal nitride exhibiting good electrical conductivity, excellent chemical stability and high corrosion resistance may be provided as a low cost overlayer for a bipolar plate separating a fuel electrode of one unit fuel cell from an oxidizing electrode of an adjoining unit fuel cell in a fuel cell stack assembly. According to certain embodiments, the bipolar plate has low contact resistance between the bipolar plate and a fuel or oxidizer electrode even in the acidic environment provided by the electrolyte of a solid polymer electrolyte fuel cell. According to certain additional embodiments, the bipolar plate maintains low interference resistance values even in the acidic environment provided by the electrolyte of a solid polymer electrolyte fuel cell.

According to other embodiments, the transition metal nitride overlayer on a bipolar plate may permit fabrication of smaller sized, lower cost fuel cell stack assemblies exhibiting excellent power generation performance. According to still other embodiments, the transition metal nitride overlayer on bipolar plates of unit fuel cells used in a fuel cell stack assembly may permit fabrication of smaller electric-powered vehicles exhibiting increased mileage per unit fuel consumption.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a cross-section view showing a configuration of a unit cell used to form a fuel cell stack according to embodiments of the present invention.

FIG. 2 is a perspective view showing the appearance of a fuel cell assembly made up of a stack of unit fuel cells separated by bipolar plates according to certain embodiments of the present invention.

FIG. 3 is an exploded plan view of the fuel cell assembly of FIG. 2 illustrating a stack of unit fuel cells separated by bipolar plates according to certain embodiments of the present invention.

FIG. 4A is a perspective plan view of a bipolar plate separating the unit fuel cells in the fuel cell stack of FIG. 3.

FIG. 4B is a cross-sectional side view of a bipolar plate separating the unit fuel cells in the fuel cell stack of FIG. 4A taken across line IIIb-IIIb.

FIG. 4C is a cross-sectional end view of a bipolar plate separating the unit fuel cells in the fuel cell stack of FIG. 4B taken across line IIIc-IIIc.

FIG. 5 is a schematic view illustrating an exemplary M₄N crystalline lattice structure for the transition metal nitride according to certain embodiments of the present invention.

FIG. 6 is a schematic view of an exemplary plasma nitriding apparatus useful for applying a transition metal nitride overlayer to a bipolar plate for a unit fuel cell according to another embodiment of the present invention

FIG. 7 is a schematic view of an alternate plasma nitriding apparatus useful for applying a transition metal nitride overlayer to a bipolar plate for a unit fuel cell according to another embodiment of the present invention

FIG. 8A is a side view illustrating an electric-powered vehicle having a compact fuel cell stack including unit fuel cells separated by a bipolar plate interposed between a face of a fuel electrode of one unit fuel cell and a face of an oxidizing electrode of an adjoining unit fuel cell, according to additional embodiments of the present invention.

FIG. 8B is a top view illustrating the electric-powered vehicle of FIG. 8A.

FIG. 9A is a cross-sectional side view illustrating the measuring method used for the measurement of contact resistance for samples prepared according to the examples and comparative examples.

FIG. 9B is a side schematic view illustrating the measuring method used for the measurement of contact resistance for samples prepared according to the examples and comparative examples.

### DETAILED DESCRIPTION

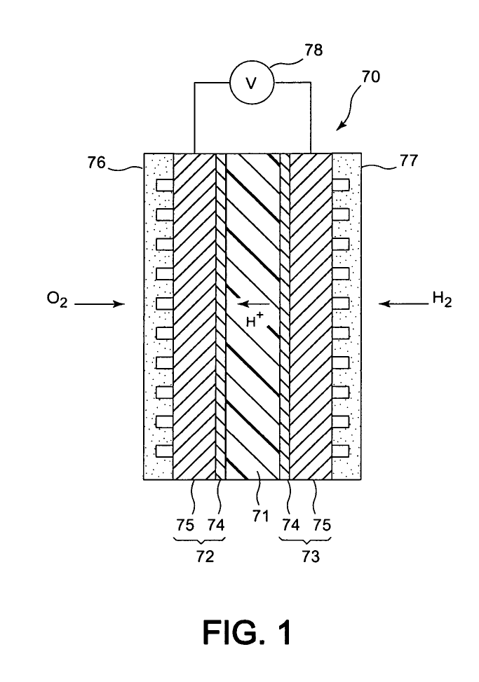

FIG. 1 is a cross-section view showing a configuration of a unit fuel cell useful in forming a fuel cell stack. As shown in FIG. 1, the unit fuel cell 70 includes a membrane electrode that is formed by joining an oxidation electrode 72 and a fuel electrode 73 to both sides of a solid polymer electrolyte membrane 71. The oxidation electrode 72 and the fuel electrode 73 each have a double layer structure containing a reaction membrane 74 and a gas diffusion layer (GDL) 75. The reaction membrane 74, which may include a redox catalyst layer, contacts the solid polymer electrolyte membrane 71.

As shown in FIG. 1, an oxidation electrode bipolar plate 76 and a fuel electrode bipolar plate 77 are installed adjacent to and contacting the outer surface of the oxidation electrode 72 and the fuel electrode 73, respectively, to provide an electrically conductive surface for connecting a stack of unit fuel cells. The bipolar plates 76 and 77 also may provide a channel for fuel gas to the fuel electrode 73 and oxidizing gas to the oxidation electrode 72. For example, an oxidizing gas (e.g. oxygen or air) channel and coolant channel may be formed by the oxidation electrode side bipolar plate 76, and a fuel gas (e.g. hydrogen) channel and coolant channel may be formed by the fuel electrode side bipolar plate 77.

The unit fuel cell 70 illustrated by FIG. 1 may be manufactured by placing the oxidation electrode 72 and the fuel electrode 73 on opposite sides of the solid polymer electrolyte membrane 71, integrating the electrodes and the membrane (e.g. by a hot press method) to form a membrane electrode assembly, and then placing the bipolar plates 76 and 77 on opposite sides of the membrane electrode assembly adjoining the exposed fuel and oxidation electrode surfaces.

After assembly, the unit fuel cell 70 may be operated by supplying a fuel gas or fuel gas mixture (e.g. a mixed gas of hydrogen, carbon dioxide, nitrogen, and steam) to the fuel electrode 73, and supplying an oxidizer gas or oxidizer gas mixture (e.g. air and steam) to the oxidation electrode 72, thereby initiating an electrochemical reaction mainly at the interfacial surface between the solid polymer electrolyte membrane 71 and the reaction membrane 74.

When oxidizer gas containing oxygen and fuel gas containing hydrogen are supplied to the oxygen gas channel and hydrogen gas channel, respectively, oxygen and hydrogen are supplied to the reaction membrane 74 via each gas diffusion layer 75, thereby causing the following electrochemical reactions at each reaction membrane 74:
Fuel electrode 73: H₂→2H⁺+2e⁻ (1)
Oxidation electrode 72: (1/2)O₂+2H⁺+2e⁻→H₂O (2)

When hydrogen gas is supplied to the fuel electrode 73, the oxidation reaction of equation (1) progresses to generate two hydrogen ions (H⁺) and two electrons (e⁻). H⁺ diffuses within the solid polymer electrolyte membrane 71 in a hydrated state (e.g. as H₃O+) and migrates to the oxidation electrode 72, while the electrons pass through the load 78 as an electrical current flowing from the fuel electrode 73 to the oxidation electrode 72. On the oxidation electrode 72 side, two hydrogen ions (H⁺) and two electrons (e⁻) combine with the supplied oxygen in the oxidizer gas to complete the reduction reaction of equation (2). The oxidation-reduction reactions thus act to generate electric power in the form of an electrical current passing through the load 78.

Because the bipolar plates 75 for the unit fuel cell 70 function to electrically connect a stack of unit fuel cells in a fuel cell stack assembly, the bipolar plates 75 should have high electrical conductivity and low contact resistance with fuel cell components, such as the gas diffusion layer 75. In addition, because the solid polymer electrolyte membrane 72 is generally formed by polymer molecules containing a plurality of sulfonic acid groups and thus has high proton activity (e.g. high acidity or low pH) particularly in a humid state corresponding to steady-state operation of the unit fuel cell 70, the bipolar plates 75 desirably have good corrosion resistance at low pH (e.g. pH 2-3).

Besides hydrogen ions generated in the fuel electrode, the oxidation electrode, through which oxygen and air pass, may produce an acidic environment when the unit fuel cell is electrically loaded to the standard unit fuel cell electrode potential of 0.6 to 1 V. Therefore, as with the fuel electrode bipolar plate 77, the oxidation electrode bipolar plate 76 must have good corrosion resistance to a strongly acidic, humid atmosphere. Furthermore, because the temperature of each gas supplied to the fuel cell may be high (e.g. 80-90° C.), the bipolar plates desirably have good high temperature corrosion resistance to aqueous acidic media.

The corrosion resistance required is that needed to maintain the electric conductivity of the bipolar plate at a sufficiently low value to produce the desired steady-state operating current for the unit fuel cell, even in this strongly acidic operating environment. It is thus necessary to measure the corrosion resistance of candidate bipolar plate materials in a low pH environment corresponding to a hydrogen ion protonating a sulfonic acid under humid conditions, as water vapor or condensed water vapor is generated by equation (2).

There have been attempts to use highly acid-resistant metal alloys, such as stainless steel, or a titanium material, including industrial pure titanium, for the bipolar plates of a fuel cell. However, during fuel cell operation, a passive film, such as an oxide containing chromium as a main metal element, a metal hydroxide or a hydrate, may be formed on the surface of the stainless steel. In a similar way, a passive film, such as titanium oxide, titanium hydroxide, or their hydrate, may be formed on the surface of the titanium. Although this passive film may increase the corrosion resistance of stainless steel and titanium to acidic media, the passive films also cause an increase in contact resistance with the surface of the diffusion layers 75, particularly when a conductive carbon paper is used as a diffusion layer.

This increased contact resistance may result in an overvoltage resistance derived from the resistance polarization within the fuel cell. This overvoltage resistance may be manifested as heat generation within the fuel cell or fuel cell stack assembly. Because this heat can be desirably recovered as exhaust heat in stationary fuel cell (e.g. cogeneration), the increase in contact resistance may improve total operating efficiency of a fuel cell stack used in a stationary cogeneration application such as a powerplant.

On the other hand, for electrically-powered vehicle applications, the exhaust heat generated by the increase in contact resistance must normally be discarded as waste heat by heat exchange with a coolant medium, as there is no practical way to use the waste heat for power cogeneration. This leads to an overall decrease in power generation efficiency for mobile fuel cell assemblies as the contact resistance increases during normal fuel cell operation. In addition, because the decrease in fuel cell stack power generation efficiency normally corresponds to an increase in heat generation, it is usually necessary to provide the fuel cell stack with a larger cooling system to account for the increase in contact resistance with operating time. Therefore, the increase in contact resistance has been a critical issue to be resolved.

In an operating fuel cell, the theoretical voltage per unit cell is 1.23 volts; however, this voltage may decrease during long term operation of the unit fuel cell due to electrode polarization, gas diffusion polarization, and resistance polarization. For electrically powered vehicle (e.g. electric-powered automobile) use, there is a need to increase the power density per unit volume or weight of the fuel cell assembly. Therefore, electric-powered vehicles may use fuel cell assemblies comprising a plurality of electrically connected unit fuel cells operating at a higher current density, for example, at a current density of 1 amp/cm², compared to fuel cell assemblies for stationary use (e.g. in power plants). When the fuel cell operating current density is maintained around 1 amp/cm², the decreased efficiency caused by the contact resistance can be reduced to an acceptable level as long as the contact resistance between the bipolar plate and the carbon paper diffusion layer is kept below about 40 mΩ cm².

Bipolar plates for fuel cells are known in which a gold plated layer is formed directly on the contact surface with the fuel or oxidizer gas electrode before press molding to create a membrane electrode assembly. Other bipolar plates for fuel cells are known in which stainless steel is formed and processed in the shape of a bipolar plate, and a passive film of a precious metal is formed on the surface, thereby reducing the contact resistance. However, the coating of precious metals on the surface of a bipolar plate in a fuel cell is time consuming and expensive, therefore adding to the cost of the fuel cell assembly.

According to some embodiments of the present invention, therefore, a transition metal nitride is provided which may be applied as a thin, electrically conductive, corrosion resistant overlayer to a surface of a bipolar plate of a unit fuel cell suitable for use in a fuel cell stack assembly in an electrically-powered vehicle. According to some additional embodiments, a method of manufacturing a bipolar plate suitable for use in a solid polymer electrolyte fuel cell is provided, in which a thin overlayer of an electrically conductive transition metal nitride is deposited on a stainless steel bipolar plate surface using plasma nitriding.

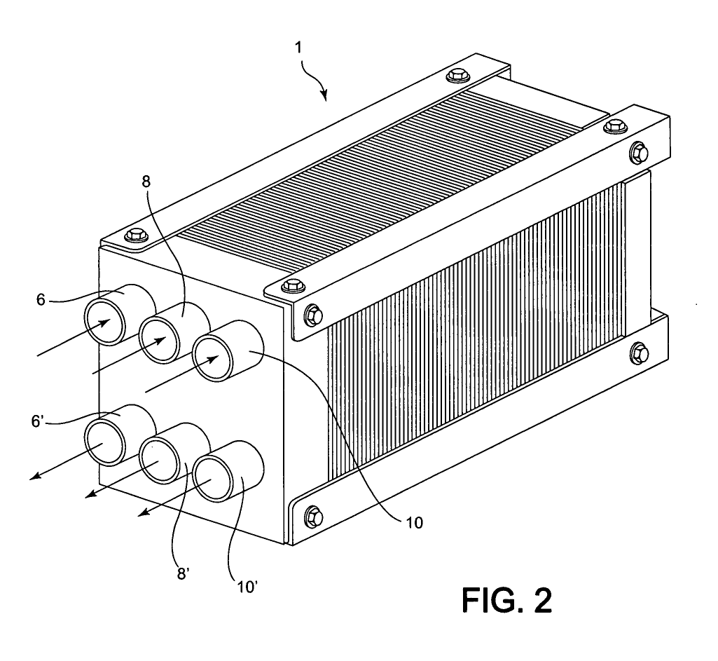

FIG. 2 is a perspective view showing the appearance of a fuel cell assembly 1 made up of a stack of unit fuel cells separated by bipolar plates according to certain embodiments of the present invention. As shown in FIG. 2, an oxidant gas supply conduit 6, a fuel gas supply conduit 8, and a coolant supply conduit 10 may be connected to an end of the fuel cell assembly 1. Similarly, an oxidant gas exhaust conduit 6′, a fuel gas exhaust conduit 8′, and a coolant exhaust conduit 10′ may also be connected to an end of the fuel cell assembly 1. The conduits may all connect to one end of the fuel cell assembly as shown in FIG. 2, or alternatively, one or more of the supply or exhaust conduits may be connected to either end of the fuel cell assembly.

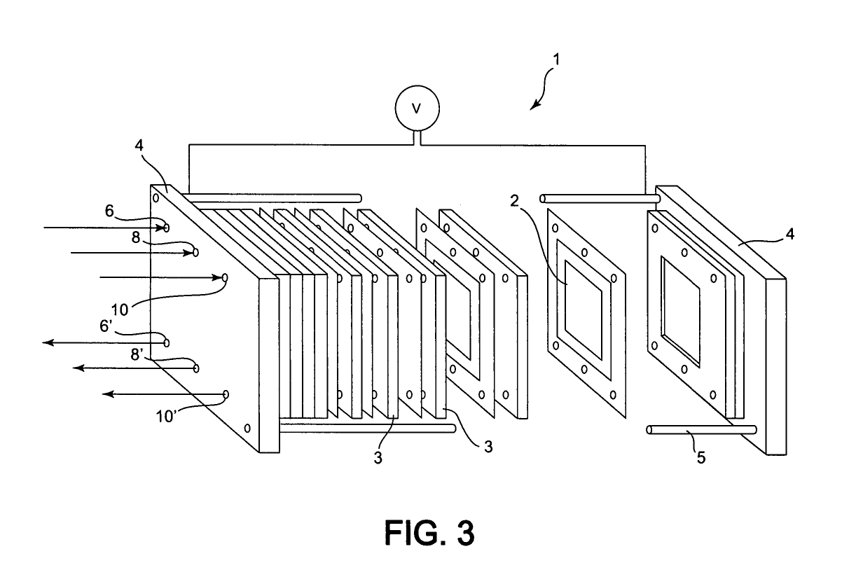

FIG. 3 is an exploded plan view of the fuel cell assembly 1 of FIG. 2 illustrating a stack of unit fuel cells separated by bipolar plates according to certain embodiments of the present invention. As shown in FIG. 3, the fuel cell assembly 1 is formed by alternately layering (i.e. stacking) a unit fuel cell 2 (each unit fuel cell 2 including a fuel electrode, an oxidizing electrode, and an electrolyte film separating the electrodes) and a bipolar plate 3 interposed between a face of a fuel electrode of one unit fuel cell and a face of an oxidizing electrode of an adjoining unit fuel cell.

Each unit fuel cell 2 has a gas diffusion layer containing an oxidizer electrode on one surface of the solid polymer electrolyte membrane, and a gas diffusion layer containing a fuel electrode on the opposing surface of the polymer electrolyte membrane, thereby forming a membrane electrode assembly. As one example, a perfluorocarbon polymer membrane containing a sulfonic acid group (Nafion 1128™, Du Pont Co., Ltd., Wilmington, Del.) may be used for the solid polymer molecule type electrolyte membrane. After forming the fuel cell stack by alternately layering the unit fuel cells 2 and the bipolar plates 3, an end flange 4 is placed on each end of the fuel cell stack and attached to the fuel cell stack with fixing bolts 5 to form the fuel cell stack assembly 1.

Each unit fuel cell also has a bipolar plate 3 positioned on each side of the membrane electrode assembly. A surface of each bipolar plate 3 may have gas feed channels to direct an oxidizer gas or a fuel gas to the membrane electrode assembly of the unit fuel cell 2. Preferably, each bipolar plate has an oxidizer gas feed channel on one major side surface, and a fuel gas feed channel on the opposite major side surface, to provide oxidizer gas to the adjoining oxidizer electrode, and fuel gas to the to the adjoining fuel electrode, respectively.

One or both of the end flanges 4 may include an oxidizer gas feed conduit 6 connected to the end flange 4 to supply an oxidizer gas containing oxygen, such as air, to the oxidizer electrode of each unit fuel cell 2, and an oxidizer gas exhaust conduit 6′ to vent unreacted oxidizer gas and reaction by-products from the oxidizer electrode. A fuel gas feed conduit 8 to supply a fuel gas containing hydrogen, such as hydrogen gas, to the fuel electrode of each unit fuel cell 2, and a fuel gas exhaust conduit 8′ to vent unreacted fuel gas and reaction by-products from the fuel electrode may also be connected to one or both of the end flanges 4 as shown in FIG. 3. Furthermore, a coolant feed conduit 10 to supply a coolant to the unit fuel cell, and a coolant exhaust conduit 10′ to remove coolant from the unit fuel cell, may also be provided in one or both of the end flanges 4 of the fuel cell stack assembly 1.

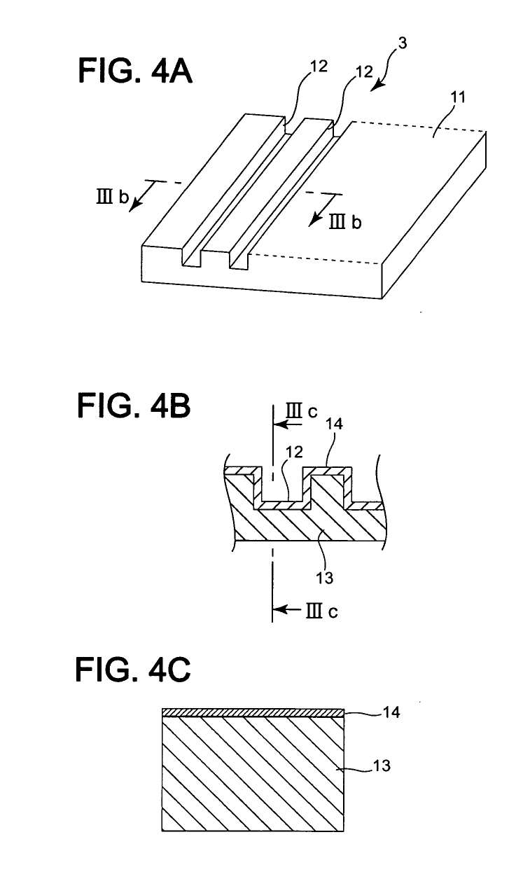

FIG. 4A is a perspective plan view of an exemplary bipolar plate 3 separating the unit fuel cells 2 in the fuel cell assembly 1 of FIG. 3. FIG. 4B is a cross-sectional side view of the bipolar plates 3 separating the unit fuel cells 2 in the fuel cell stack assembly 1 of FIG. 4A taken across line IIIb-IIIb. FIG. 4C is a cross-sectional end view of the bipolar plates 3 separating the unit fuel cells 2 in the fuel cell stack assembly 1 of FIG. 4B taken across line IIIc-IIIc. As shown in FIG. 4A, at least one major surface of each bipolar plate 3 may include a plurality of rectangular channels 12 configured to supply a fuel gas or oxidizer gas to the fuel gas electrode or oxidizing gas electrode side of the membrane electrode assembly. As shown in FIG. 4A, the channels 12 may be formed in the top surface 11 a transition metal nitride overlayer applied to the surface of the bipolar plate 3 for the unit fuel cell. As shown in FIGS. 4B and 4C, bipolar plate 3 has a base layer 13 that may comprise a stainless steel and an overlayer 14 that may comprise nitrided layer and that may be formed directly on the base layer extending along the outer surface of each channel 12.

The base layer 13 may be formed of stainless steel containing Fe as a major component, Cr, and at least one element of Ni or Mo. The stainless steel containing these elements may include an austenitic stainless steel, an austenitic-ferritic stainless steel, and a precipitation hardened stainless steel. Among them, an austenitic stainless steel is particularly favorable to form the base layer 13. Suitable austenitic stainless steels include, for example, SUS304, SUS310S, SUS316L, SUS317J1, SUS317J2, SUS321, SUS329J1, and SUS836. In certain embodiments, it is preferable to use SUS310U or SUS317J2 stainless steel with a relatively higher Cr content. The nitrided overlayer 14 may be a transition metal nitride with a M₄N lattice structure, where nitride atoms are placed in an octahedron space in a unit cell center of the face-centered lattice formed by Fe as a major component and a transition metal atom selected from Fe, Cr, Ni and Mo.

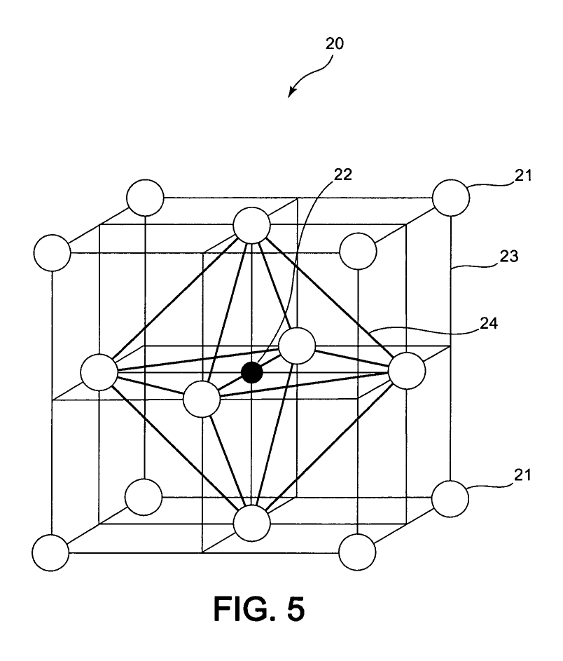

FIG. 5 shows an exemplary schematic M₄N crystalline lattice structure 20 for an exemplary nitrided overlayer 14. The M₄N lattice structure 20 may be a face-centered cubic unit cell including a transition metal atom 21, selected from iron (Fe), chromium (Cr), nickel (Ni) or Molybdenum (Mo), positioned at each corner and face-center of the unit cell as shown in FIG. 5. Preferably, iron atoms comprise a major component of the M₄N lattice structure. A nitrogen atom 22 may be positioned at the center of the face-centered cubic unit cell within an octahedral lattice structure formed by the transition metal atoms positioned at the face-centers of the unit cell, as shown in FIG. 5. The chemical formula of this nitride layer 14 may be represented as (Fe_{100-x-y-z}, Crₓ, Ni_{y}Mo_{z})₄N_{w}, in which 0.8≦w≦1.7, 19≦x≦30, 11≦y≦19, and 0≦z≦3. In certain embodiments, 0.8≦w≦1, 19≦x≦27, 11≦y≦15, and 0≦z≦3. In other embodiments, 0.8≦w≦1.7, 25≦x≦27, 13≦y≦19, and 0≦z≦1.

In the M₄N lattice structure, M refers to the transition metal atom 21 selected from Fe, Cr, Ni and Mo, and N refers to the nitrogen atom 22. The nitrogen atom 22 may occupy a quarter of an octahedron space in a unit cell center of the M₄N lattice structure 20. That is, the M₄N lattice structure 20 may take the form of an interstitial solid solution where the nitrogen atom 22 invades the octahedron space of the unit cell center of the face-centered cubic lattice for the transition metal atom 21. Shown at the center of the crystalline lattice of a cubic crystal in FIG. 5, the nitrogen atoms 22 may be positioned at the lattice coordinates (0,0,1/2), (0,1/2,0), (1/2,0,0), (1/2, 1/2, 1/2) for every unit cell. Within this M₄N lattice structure 20, the transition metal atoms M 21 include Fe atoms as a major component, and may be in the form of an alloy, in which Fe is partially replaced with other transition metal atoms, such as Cr, Ni, and Mo.

In certain exemplary embodiments, the composition of the transition metal nitride may be characterized by the chemical formula (Fe_{100-x-y-z}, Crₓ, Ni_{y}Mo_{z})₄N_{w}, in which the subscripts w, x, y, and z in the formula indicate the atomic percent of each element, and these subscripts fall within a range of 0.8≦w≦1.7, 19≦x≦30, 11≦y≦19, and 0≦z≦3. In certain exemplary embodiments, 0.8≦w≦1, 19≦x≦27, 11≦y≦15, and 0≦z≦3. In other exemplary embodiments, 0.8≦w≦1.7, 25≦x≦27, 13≦y≦19, and 0≦z≦1. In additional exemplary embodiments, the transition metal nitride may be characterized by the relationship 5.9≦{0.01[6(atomic percent Fe)+5(atomic weight percent Cr)+8(atomic weight percent Ni)+5 (atomic weight percent Mo)]}≦6.1.

While not wishing to be bound by any theory, presently available information indicates that when the transition metal nitride shows strong covalent bonding between the transition metal atom and the nitrogen atom by maintaining the metal binding among transition metal atoms, the reactivity to oxidation of each transition metal atom in the nitride decreases. Therefore, the transition metal nitride may be chemically stable even in the acidic environment within the fuel cell assembly. In some embodiments, the transition metal nitride may feature both good chemical stability and high electrical conductivity required for use as an overlayer for a bipolar plate used in a unit fuel cell. In addition, since stainless steel is often used as a base layer for a bipolar plate in a unit fuel cell, an overlayer comprising such a transition metal nitride formed directly on the base layer may exhibit a low contact resistance with respect to the carbon paper generally used as a diffusion layer in the unit fuel cell, even in an acidic environment within an electric-power generating fuel cell stack assembly.

Furthermore, since the contact resistance can be controlled without forming a gold plated layer directly on the surface of the stainless steel bipolar plate, it may be possible to reduce the cost of manufacturing the bipolar plates and thus the fuel cell stack assembly. Moreover, the transition metal nitride layer with the M₄N lattice structure may have good chemical stability and corrosion resistance; therefore, it may be possible to provide a bipolar plate for a fuel cell that maintains a low contact resistance between the bipolar plate and the fuel and/or oxidizer electrode in an acidic environment.

In the bipolar plates 3 of a fuel cell assembly 1, when the atomic ration of Cr to Fe contained in the nitrided layer 14 is high, nitrogen contained in the nitrided layer 14 may bond with Cr in the nitrided layer 14 to form a covalently bonded nitrogen salt compound such as chromium nitride (CrN) as a major component. Again, while not wishing to be bound by any theory, presently available information indicates that a high chromium content in the nitrided layer 14 may result in increased corrosion of the nitrided layer 14 under some circumstances. Accordingly, in some embodiments, it is preferred for the transition metal atoms 21 to be mainly composed of Fe atoms.

The transition metal nitride according to some embodiments of the present invention has a M₄N lattice structure where nitrogen atoms are placed in an octahedron space in a unit cell center of the face-centered cubic lattice that is formed by Fe as a major component and a transition metal atom selected from Fe, Cr, Ni and Mo. In addition, there may be strong covalent bonds between the transition metal atoms and the nitrogen atoms even with strong metallic bonds between the transition metal atoms, as there is bonding with the transition metal atoms from the insertion of nitrogen atoms at the octahedral void located at the center of the unit cell of the face-centered cubic lattice formed by the transition metal atoms. Therefore, it may be possible to provide a transition metal nitride overlayer that features both chemical stability to maintain the conductivity required for a bipolar plate in a unit fuel cell operating in a highly acidic environment, as well as outstanding corrosion resistance and low contact resistance.

In addition, it may be possible to realize superior corrosion resistance and low contact resistance in a low cost bipolar plate for fuel cells using this metal nitride as an overlayer according to some embodiments of the invention. Furthermore, in additional embodiments, it may be possible to realize a small, low cost fuel cell stack capable of maintaining a high generating efficiency without damaging the generator's capability, using the bipolar plate having a metal nitride overlayer according to embodiments of the present invention.

Bipolar plates 3 for the fuel cell assembly 1 according to some embodiments of the present invention may have a transition metal nitride with the M₄N crystal lattice structure as a nitrided overlayer. In one exemplary embodiment, the bipolar plate on which the nitrided overlayer is deposited comprises a stainless steel surface with chemical compositions listed as 18 [wt %]≦Cr≦26 [wt %], 11 [wt %]≦Ni≦21 [wt %], and 0 [wt %]≦Mo≦5 [wt %], and having Fe as the major component. The nitrided overlayer may be applied using, for example, plasma nitriding, in which there is formed a nitride layer having a cubic crystal structure in which the nitrogen atoms are placed in an octahedron void located at the center of the unit cell of a face-centered cubic lattice which is formed by transition metal atoms which are selected from Fe, Cr, Ni, and Mo. Such an overlayer may provide good chemical stability, corrosion resistance and low cost when used to fabricate a bipolar plate 3.

In another embodiment of a manufacturing method for a bipolar plate in a unit fuel cell, a thin overlayer of the transition metal nitride may be deposited on a surface of a bipolar plate using a deposition process, for example, a plasma deposition process as described below. This exemplary manufacturing method for the bipolar plate of the unit fuel cell is characterized by forming a nitrided overlayer with a M₄N lattice structure where nitrogen atoms are placed in an octahedron space in a unit cell center of the face-centered cubic lattice that is formed by Fe as a major component and a transition metal atom selected from Fe, Cr, Ni and Mo.

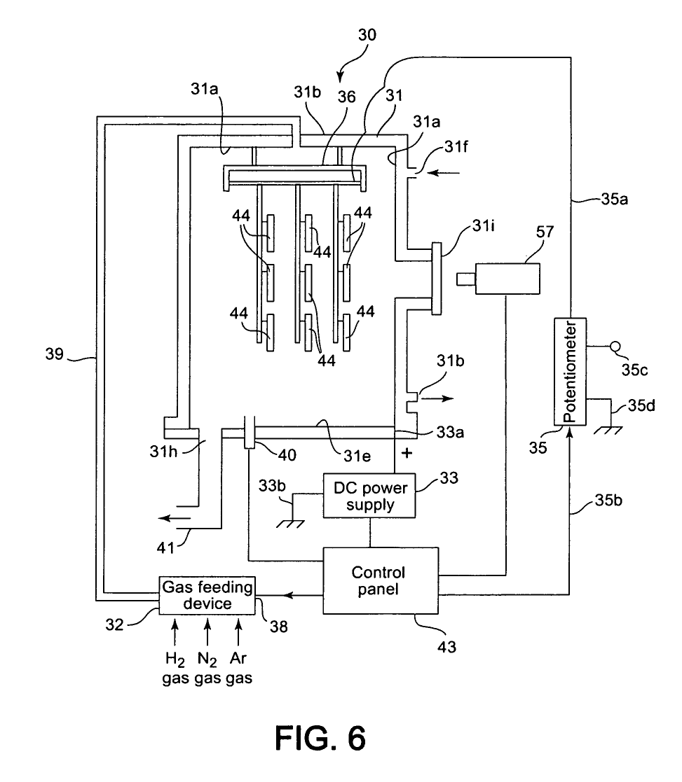

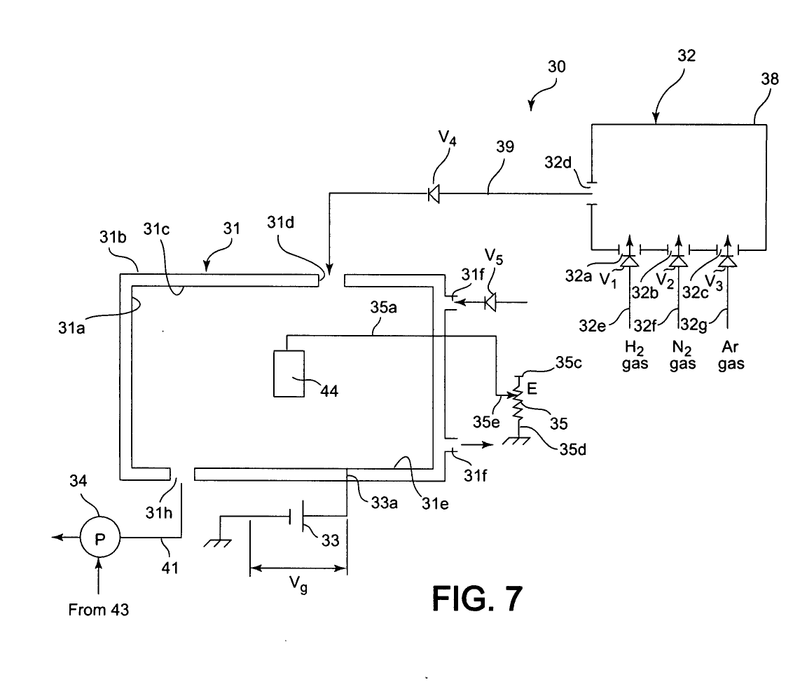

A plasma nitriding treatment is one exemplary method to produce a transition metal nitride overlayer on a bipolar plate surface configured as a cathode in a plasma deposition apparatus. A glow discharge, that is, a low-temperature non-equilibrium plasma, is generated by applying direct voltage to ionize a portion of the feed gas components, and deposit the nitride on the metal cathode surface by high-speed accelerated collision of the ionized gas components within the non-equilibrium plasma with the surface of the bipolar plate surface. FIG. 6 is a schematic view of an exemplary plasma nitriding apparatus 30 useful for applying a transition metal nitride overlayer to a pluirality of bipolar plates according to another embodiment of the present invention. FIG. 7 is a schematic view of an alternate plasma nitriding apparatus 30 useful for applying a transition metal nitride overlayer to a bipolar plate for a unit fuel cell according to another embodiment of the present invention

The nitriding device 30 contains a batch nitriding furnace 31, a gas feeding device 32 for supplying atmospheric gas to the nitriding furnace 31, plasma electrodes 33a and 33b for generating plasma within the nitriding furnace 31, a direct-current power supply 33 for supplying direct-current voltage to these electrodes 33a and 33b, a blower 34 for discharging gas within the nitriding furnace 31, and a temperature sensor 37 for detecting the temperature within the nitriding furnace 31. The nitriding furnace 31 is equipped with an inner wall 31a and an outer wall 31b, and a stainless hanger 36 is installed on the ceiling 31c of the inner wall 31a in order to hang a stainless steel foil 44 that is processed in a shape of a bipolar plate for a fuel cell. A gas feeding device 32 is connected to the gas chamber 38 through a gas feed conduit 39, and the gas chamber 38 has openings 32a, 32b, 32c and 32d. The openings 32a, 32b and 32c communicate with a hydrogen (H₂) gas feeding line 32e, a nitrogen (N₂) gas feeding line 32f, and an argon (Ar) gas feeding conduit 32g, which are each equipped with gas feeding valves V1, V2 and V3, respectively. The gas feeding device 32 has an opening 32d communicating with one end of the gas feeding conduit 39.

On the ceiling 31c of the nitriding furnace 31, there is shown an opening 31d communicating with the other end of the gas feeding conduit 39. The gas feeding valve V4 is located in the gas feeding conduit 39. The gas pressure within the nitriding furnace 31 may be detected by the gas pressure sensor 40 installed on the base 31e of the nitriding furnace 31. There may also be a coolant channel (not shown in the figures) in the nitriding furnace 31. The coolant flows from the opening 31f installed on the outer wall 31b of the nitriding furnace 31 to the coolant channel and ultimately out of the opening 31g. The opening 31f has the coolant feeding valve V5, to adjust the coolant flow. The pump 34 is connected with the drainage conduit 41 communicating with the opening 31h installed on said base 31e. The temperature sensor 37 is installed on the setting hole 31i on the outer wall 31b of the nitriding furnace 31.

In addition to the direct-current power supply 33 controlled by the control panel 43 for glow discharge, the potentiometer 35 for the bias is installed on the nitride device 30. The anode (+) 33a of the direct-current power supply 33 is connected to the inner wall 31a of the nitriding furnace 31 and the cathode (−) is grounded. The potentiometer 35 divides the difference in potential between the direct-current power supply terminal 35c for bias and the earth circuit 35d by the movable contact 35e within a range of 0 V and bias voltage. The obtained voltage is supplied to each stainless steel foil 44 via the bias circuit 35a. The direct-current power supply 33 is turned on or off by a control signal from the control panel 43.

The potentiometer 45 receives the bias control signals from the control panel 43 via the bias control circuit 35b. In response to the control signals, the movable contact 35e slides. Accordingly, each stainless steel foil 44 has voltage difference derived from applying voltage between terminals of the direct-current power supply 33 and bias voltage supplied via the movable contact 35e to the inner wall 31a. The gas feeding device 32 and the gas pressure sensor 40 are also controlled by the control panel 43.

In some embodiments, it is desirable to use nitrogen gas and hydrogen gas for plasma nitriding, and to conduct nitriding of a stainless steel material at 400 to 500° C. by applying a negative bias voltage to the stainless steel material within the low-temperature non-equilibrium plasma where nitrogen gas and hydrogen gas are discharged. In the plasma nitriding treatment, the passive film on the surface of metal materials can be easily removed by applying a sputtering action by using ion bombardment.

On the other hand, when a nitriding treatment is conducted by generally used gas nitriding or salt bath nitriding, an insulating oxide may be formed by oxidation of the top layer of the nitrided layer, typically to a depth of about 3 to about 40 nm. Therefore, the contact resistance of the bipolar plate with respect to the carbon paper generally used as a gas diffusion layer in the fuel cell, may increase to unacceptable levels.

Consequently, a nitriding treatment using a plasma nitriding method as provided by embodiments of the present invention promotes the nitriding reaction while removing oxygen on the surface of the metal materials used to form the base layer of the bipolar plate. This allows suppression of the oxygen level within the top surface layer of the metal material to sufficiently low levels after nitriding. It is also possible to maintain the value of the contact resistance with the carbon paper diffusion layer at a low value preferable for fuel cell operation.

With reference to exemplary manufacturing methods for the bipolar plate of the fuel cell, according to some embodiments of the present invention, it may be possible to manufacture a bipolar plate for a fuel cell which maintains a low value of the contact resistance even in an acidic environment, has excellent corrosion resistance, and actualizes cost reduction by easy operations. These embodiments generally involve use of a base layer that is formed from stainless steel containing Fe as a major component, Cr, and at least any one element of Ni or Mo and a nitrided overlayer comprising a transition metal nitride formed directly on the base layer.

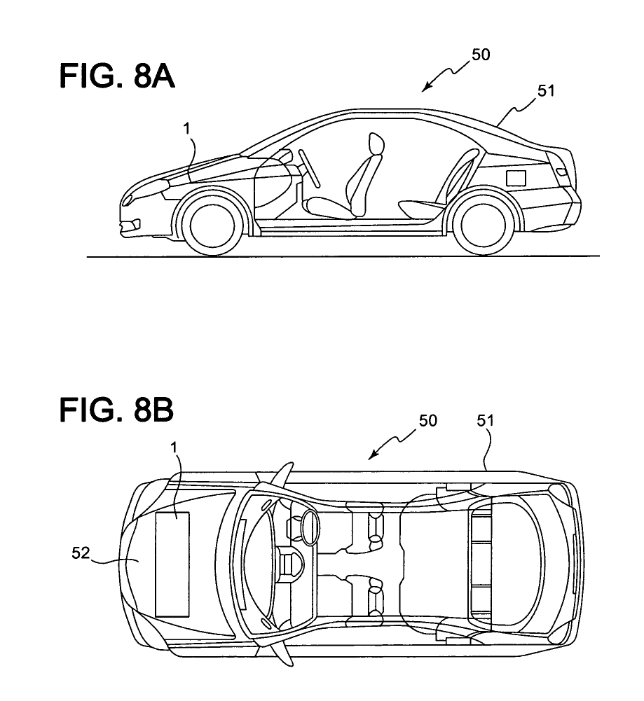

In other embodiments, fuel cell assemblies for use in electric-powered vehicles may be fabricated using bipolar plates having a nitrided overlayer. As one example of an electric-powered vehicle using a fuel cell assembly according to the present invention, we now describe an electric-powered automobile using a fuel cell stack assembly. However, fuel cell assemblies according to the present invention may be used in other electric-powered vehicles, for example, trucks, trains, boars, aircraft, and the like. FIG. 8A is a side view illustrating an electric-powered automobile 50 having a compact fuel cell assembly 1 including unit fuel cells separated by a bipolar plate interposed between a face of a fuel electrode of one unit fuel cell and a face of an oxidizing electrode of an adjoining unit fuel cell, according to additional embodiments of the present invention. FIG. 8B is a top view illustrating the electric-powered vehicle of FIG. 8A.

As shown in FIG. 8 (b), in a front of the car body 51, there are right and left front side members and hood ridges as well as an engine compartment part 52 wherein lower members connect both hood ridges including the front side members, which are connected by welding, for example. The particular electric-powered automobile 70 shown in FIG. 8 (a) and (b) mounts the fuel cell assembly 1 within the engine compartment part 52, although other mounting positions, for example within the rear trunk compartment or underneath the floor area of the automobile, are within the scope of the invention.

By mounting in an electric-powered vehicle a fuel cell stack 1 having high power generation efficiency, and in which the fuel cell bipolar plate is fabricated according to embodiments of the present invention, it may be possible to improve the fuel consumption of the fuel cell electric car. In addition, by mounting the downsized light fuel cell stack 1 on or within a vehicle, it may be possible to reduce the weight of the vehicle body, thereby reducing fuel consumption and thus increasing fuel mileage. Furthermore, by mounting the downsized fuel cell on mobile electric-powered automobiles and the like, it may be possible to provide larger spaces within the vehicle interior for passenger use (e.g. for storage of personal belongings, luggage, packages, and the like) and to expand the styling options for the vehicle.

### EXAMPLES

Examples 1 to 17, as compared to Comparative Examples 1 to 5, describe fabrication and use of bipolar plates for fuel cells according to various embodiments of the present invention. These examples are the result of investigations of the efficacy of various bipolar plate constructions in unit fuel cells and fuel cell assemblies according to the present invention.

In each example, the base layer of the bipolar plate is a stainless steel material regulated by Japanese Industry Standards (JIS), such as SUS316L, SUS310S, SUS317L, SUS317J1, and SUS317J2 stainless steel. Each overlayer was applied to a 0.1 mm thick stainless steel base layer using plasma nitriding after washing and degreasing the base layer material. Table 1 shows the type of stainless steel used in the base layer and the chemical composition thereof in weight percent (wt %) as well as the atomic percent (at %).

TABLE 1

| | | Chemical | | | | Atomic | | | | |
|---|---|---|---|---|---|---|---|---|---|---|
| | | Composition | | | | Percent | | | | Value |
| | Steel | (Weight %) | | | | (Atomic %) | | | | of X in |
| | Type | Fe | Cr | Ni | Mo | Fe | Cr | Ni | Mo | M₄Nₓ |
| Example 1 | SUS316L | 68 | 18 | 12 | 2 | 68 | 19 | 11 | 1 | 1 |
| Example 2 | SUS316L | 68 | 18 | 12 | 2 | 68 | 19 | 11 | 1 | 0.9 |
| Example 3 | SUS310S | 55 | 25 | 20 | 0 | 55 | 27 | 19 | 0 | 1 |
| Example 4 | SUS310S | 55 | 25 | 20 | 0 | 55 | 27 | 19 | 0 | 0.8 |
| Example 5 | SUS317L | 64 | 18 | 15 | 3 | 64 | 20 | 14 | 2 | 0.9 |
| Example 6 | SUS317L | 64 | 18 | 15 | 3 | 64 | 20 | 14 | 2 | 0.8 |
| Example 7 | SUS317J1 | 62 | 17 | 16 | 5 | 63 | 19 | 15 | 3 | 0.9 |
| Example 8 | SUS317J1 | 62 | 17 | 16 | 5 | 63 | 19 | 15 | 3 | 0.8 |
| Example 9 | SUS317J2 | 60 | 25 | 14 | 1 | 60 | 27 | 13 | 0.6 | 0.9 |
| Example 10 | SUS317J2 | 60 | 25 | 14 | 1 | 60 | 27 | 13 | 0.6 | 0.8 |
| Example 11 | SUS302 | 75 | 17 | 8 | 0 | 74 | 18 | 8 | 0 | 0.9 |
| Example 12 | SUS316L | 68 | 18 | 12 | 2 | 68 | 19 | 11 | 1 | 1.1 |
| Example 13 | SUS316L | 68 | 18 | 12 | 2 | 68 | 19 | 11 | 1 | 1.3 |
| Example 14 | SUS310S | 55 | 25 | 20 | 0 | 55 | 27 | 19 | 0 | 1.3 |
| Example 15 | SUS310S | 55 | 25 | 20 | 0 | 55 | 27 | 19 | 0 | 1.7 |
| Example 16 | SUS317J2 | 60 | 25 | 14 | 1 | 60 | 27 | 13 | 0.6 | 1.3 |
| Example 17 | SUS317J2 | 60 | 25 | 14 | 1 | 60 | 27 | 13 | 0.6 | 1.7 |
| Comparative | SUS316L | 68 | 18 | 12 | 2 | 68 | 19 | 11 | 1 | — |
| Example 1 | | | | | | | | | | |
| Comparative | SUS310S | 55 | 25 | 20 | 0 | 55 | 27 | 19 | 0 | — |
| Example 2 | | | | | | | | | | |
| Comparative | SUS317L | 64 | 18 | 15 | 3 | 64 | 20 | 14 | 2 | — |
| Example 3 | | | | | | | | | | |
| Comparative | SUS317J1 | 62 | 17 | 16 | 5 | 63 | 19 | 15 | 3 | — |
| Example 4 | | | | | | | | | | |
| Comparative | SUS317J2 | 60 | 25 | 14 | 1 | 60 | 27 | 13 | 0.6 | — |
| Example 5 | | | | | | | | | | |

In Examples 1 to 17, the plasma nitriding overlayer was applied at a temperature range of 450 to 500° C. for 60 minutes of processing time using a processing gas mixing ratio N₂:H₂ of 1:1, and a processing gas pressure of 3 to 7 mm Hg (399-665 Pa) to obtain the Example 1 to 17 as shown in Table 2. Plasma nitriding was not carried out on Comparative Examples 1 to 5.

Each sample was evaluated by following methods:

Identification of a Nitrided Layer

Identification of the nitrided layer for samples obtained by said methods was conducted by an X-ray diffraction measurement of the nitrided surface. An x-ray diffraction device (XRD) (manufactured by MacScience Co., Ltd.) was used for measuremens of the crystalline lattice structure. The measurement was conducted under the condition of CuKα line of the radiation source, 20 to 100° diffraction angle, and a 2°/min scan speed.

Measurement of the Thickness of the Nitrided Layer

The thickness of the nitride compound layer was measured by a cross-section observation using a light microscope or a scanning electron microscope.

Determination of the Nitrogen Content of the Nitrided Layer

The nitrogen content in the nitrided layer, that is, X value when the formula of the nitrided layer is expressed as M₄Nₓ, was determined by averaging the measured values between the depth 100 to 200 nm using depth-profiling Auger electron spectroscopy analysis. A MODEL4300 (manufactured by PHI Co.) was used to measure the composition of the nitrided overlayer. The measurement was conducted under the conditions of 5 kV of electron beam accelerating voltage, 20 μm×16 μm measuring area, 3 kV ion gun accelerating voltage, and 10 nm/min sputtering rate (expressed as a SiO₂ equivalent value).

Measurement of the Contact Resistance of the Nitrided Layer

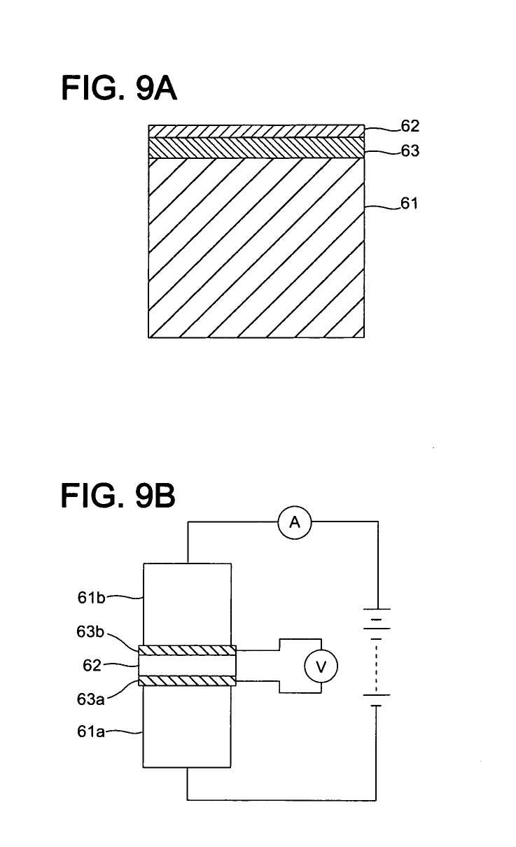

The samples obtained from Examples 1 to 11 and Comparative Examples 1 to 5, are cut out in a size of 30 mm×30 mm to measure the contact resistance. A TRS-2000SS instrument manufactured by Ulvac-Riko, Inc. was used for measuring the pressure load contact electric resistance. As shown in FIG. 9(a), a carbon paper layer 63 was interposed between the electrode 61 and the sample 62. As shown in FIG. 9(b), the electrode construction was prepared by forming layers as follows: electrode 61a/carbon paper 63a/sample 62/carbon paper 63b/electrode 61b.

TABLE 2

| | | | Nitrided Layer | | |
|---|---|---|---|---|---|
| | | Nitriding | Characteristics | | Value |
| | Nitriding | Temperature | | Thickness | of X in |
| | Method | (° C.) | Structure | (μm) | M₄Nₓ |
| Example 1 | Plasma | 500 | M₄N | 5.0 | 1 |
| | nitriding | | | | |
| Example 2 | Plasma | 450 | M₄N | 4.5 | 0.9 |
| | nitriding | | | | |
| Example 3 | Plasma | 500 | M₄N | 3.8 | 1 |
| | nitriding | | | | |
| Example 4 | Plasma | 470 | M₄N | 3.5 | 0.8 |
| | nitriding | | | | |
| Example 5 | Plasma | 500 | M₄N | 3.0 | 0.9 |
| | nitriding | | | | |
| Example 6 | Plasma | 470 | M₄N | 2.5 | 0.8 |
| | nitriding | | | | |
| Example 7 | Plasma | 500 | M₄N | 2.5 | 0.9 |
| | nitriding | | | | |
| Example 8 | Plasma | 470 | M₄N | 1.8 | 0.8 |
| | nitriding | | | | |
| Example 9 | Plasma | 500 | M₄N | 3.5 | 0.9 |
| | nitriding | | | | |
| Example 10 | Plasma | 470 | M₄N | 3.5 | 0.8 |
| | nitriding | | | | |
| Example 11 | Plasma | 470 | M₄N | M₄N | 0.9 |
| | nitriding | | (100%) | (100%) | |
| Example 12 | Plasma | 450 | M₄N | 5.0 | 1.1 |
| | nitriding | | | | |
| Example 13 | Plasma | 420 | M₄N | 4..5 | 1.3 |
| | nitriding | | | | |
| Example 14 | Plasma | 450 | M₄N | 3.1 | 1.3 |
| | nitriding | | | | |
| Example 15 | Plasma | 420 | M₄N | 2.5 | 1.7 |
| | nitriding | | | | |
| Example 16 | Plasma | 470 | M₄N | 3.5 | 1.3 |
| | nitriding | | | | |
| Example 17 | Plasma | 420 | M₄N | 3.5 | 1.7 |
| | nitriding | | | | |
| Comparative | None | — | None | None | — |
| Example 1 | | | | | |
| Comparative | None | — | None | None | — |
| Example 2 | | | | | |
| Comparative | None | — | None | None | — |
| Example 3 | | | | | |
| Comparative | None | — | None | None | — |
| Example 4 | | | | | |
| Comparative | None | — | None | None | — |
| Example 5 | | | | | |

The electrical resistance was measured twice at 1 amp/cm² of applied electric current and 1.0 MPa of surface pressure, and the average value of each measured electrical resistance was determined as the contact resistance value. The contact resistance value was measured twice before and after the below mentioned corrosion test. Using the contact resistance value after the corrosion test, the corrosion resistance in an acidic environment was evaluated in a simulated environment where the bipolar plate for the fuel cell was exposed within the fuel cell stack. Carbon paper (TGP-H-090 by Toray Industries, Inc., 0.26 mm thickness, 0.49 g/cm³ bulk density, 73% void ratio, 0.07Ω·cm² through-thickness volume resistivity) was used, on which a platinum catalyst supported by carbon black was applied. A diameter φ20 mm

Evaluation of Corrosion Resistance Using Standard Hydrogen Electrodes

After the samples obtained from above mentioned Examples 1 to 11 and Comparative Examples 1 to 5 were cut out, in the size of 30 mm×30 mm, and an electric chemical method of the constant-potential electrolysis test was implemented, the corrosion current density was measured and the degree of decrease in corrosion resistance was evaluated. In the fuel cell, the maximum 1 V versus Standard Hydrogen Electrode (SHE) of potential is applied to the oxidation electrode side compared to the fuel electrode side. In addition, the solid polymer electrolyte membrane utilizes the proton conductivity by the hydrating polymer electrolyte membrane having a proton-exchange group, such as sulfonic acid group in molecules to saturate, and it shows strong acidity. Therefore, after keeping applying potential for a certain period, the corrosion current density was measured to evaluate the corrosion resistance. The condition of the constant-potential electrolysis test is determined as applying 1 V versus SHE potential at a temperature of 80° C. and retaining it for 100 hours.

Evaluation of Corrosion Resistance Using Immersion Experiment

The samples from Examples 12-17 were evaluated for corrosion resistance using an immersion experiment that is a quantitative test for measuring the increase in contact resistance due to corrosion. In a standard fuel cell, the bipolar plate is separated from the cathode and anode by carbon paper that is used as a gas diffusion layer. Thus, even in a fuel cell operating environment in which water formed by the reaction condenses on the bipolar plate, there are instances when the condensed water drops remain isolated from the electrodes.

In addition, even though water typically may be found in the contact point between the bipolar plate and the carbon paper, the amount of water may be insufficient to support electrolysis, and the ion conductivity may remain unusually low. It is possible, in some cases, for the electrons to migrate between the bipolar plate, which supports electron migration, and the carbon paper. Because the ion conductivity may be unusually low, the ions may not be able to move far from the electrodes to the vicinity of the bipolar plate through the condensed water layer. Because of this limitation, it is generally not possible to view the bipolar plate and electrodes as a single electrochemical cell, but rather, as electrochemical cells connected in series. Thus, the bipolar plate's electrical potential may be considered as a separate electrical potential separate from the electrode potential.

Using an immersion cell, applicants devised a test method to simulate the operating environment of a fuel cell without imposing an electrical potential on the bipolar plate material. By comparing the electrical potential after immersing the experimental bipolar cell material in an acidic solution with a controlled potential electrolysis experiment, and by performing the experiment under exacting conditions relating to contact resistance increases, applicants developed a test method able to detect the increase in contact resistance resulting from corrosion of an bipolar plate in a non-operating environment.

Thus, contact resistance values and corrosion current densities were measured for the bipolar plates of Examples 12-17 without impressing any potential on the bipolar plate materials, and by measuring the increase in contact resistance after maintaining the bipolar plate material in the solution for a fixed period. The conditions of the immersion experiment included immersing the experimental bipolar plate materials in an aqueous sulfuric acid solution at pH 4 and at a temperature of 80° C. for 100 hours. In this manner, a measure of contact resistance change over time was determined, which can be related to the chemical stability of the nitride overlayer.

Table 3 below shows the contact resistance values and the corrosion current densities before and after the immersion test on Examples 1-11. As shown in Tables 2 and 3, a transition metal nitride represented by (Fe_{100-x-y-z}CrₓNi_{y}Mo_{z})₄N_{0.8-1}, wherein x, y and z are within the ranges of 19≦x≦27, 11≦y≦15, and 0≦z≦3, is formed by plasma nitriding a stainless steel substrate or base layer at 400 to 500° C., thereby forming a nitrided layer comprising a M₄N lattice structure directly on the base layer. In this nitrided layer, the metal binding between the transition metal atoms is maintained, and the transition metal atom and the nitrogen atom show strong covalence, which chemically stabilizes each metal atom in the nitrided layer.

TABLE 3

| | Contact Resistance (mΩ-cm²/2 surfaces) | | Corrosion |
|---|---|---|---|
| | Before the | After the | Current |
| | Electrolysis | Electrolysis | Density |
| | Test | Test | (μA/cm²) |
| Example 1 | 9.0 | 18.0 | 5.3 |
| Example 2 | 10.0 | 19.0 | 7.0 |
| Example 3 | 10.0 | 21.0 | 7.3 |
| Example 4 | 14.0 | 34.0 | 8.0 |
| Example 5 | 16.0 | 26.0 | 10.0 |
| Example 6 | 11.0 | 18.0 | 9.0 |
| Example 7 | 12.0 | 24.0 | 10.0 |
| Example 8 | 10.0 | 23.0 | 9.0 |
| Example 9 | 15.0 | 41.0 | 10.0 |
| Example 10 | 13.0 | 39.0 | 9.5 |
| Example 11 | 13.0 | 98.0 | 9.0 |
| Comparative | 377.0 | 1460.0 | 7.0 |
| Example 1 | | | |
| Comparative | 123.0 | 944.0 | 9.0 |
| Example 2 | | | |
| Comparative | 262.0 | 1383.0 | 10.2 |
| Example 3 | | | |
| Comparative | 709.0 | 1823.0 | 18.2 |
| Example 4 | | | |
| Comparative | 448.0 | 1489.0 | 20.1 |
| Example 5 | | | |

In addition, the plasma nitriding treatment was not used to prepare Comparative Examples 1 to 5, and thus a passive (oxidized) film was formed on the surface of the stainless steel. Therefore, these samples exhibited excellent corrosion resistance, as reflected by the low corrosion current densities; however, the contact resistance was high before and after the electrolysis test, making these examples unsuitable for long term use as bipolar plates in a fuel cell assembly.

Table 4 shows the contact resistance values before and after the immersion experiments for Examples 12-17. The contact resistance after the immersion experiment for Examples 12-17 was approximately 30-50 [Ω-cm²], and even after the immersion experiment, the contact resistance was comparatively low. While not wishing to be bound by any particular theory, applicants presently believe that the reason for this low contact resistance may be that the oxidation stability of the formed nitride is low, and that the surface of the formed nitride layer is finely oxidized after completion of the immersion experiment.

TABLE 4

Contact Resistance (mΩ-cm²/2 surfaces)

| | | After |
|---|---|---|
| | Before | Immersion |
| | Immersion | (100 Hours) |
| Example 12 | 9.0 | 52.0 |
| Example 13 | 10.0 | 41.0 |
| Example 14 | 10.0 | 35.0 |
| Example 15 | 14.0 | 28.0 |
| Example 16 | 16.0 | 37.0 |
| Example 17 | 11.0 | 30.0 |

As shown in Table 1, the composition of the nitrided overlayer in each of Examples 12-17 may be characterized by the chemical formula (Fe_{100-x-y-z}CrₓNi_{y}Mo_{z})₄N_{w}, in which the subscripts w, x, y, and z in the formula indicate the atomic percent of each element, and these subscripts fall within a range of 0.8≦w≦1.7, 25≦x≦27, 13≦y≦19, and 0≦z≦1. The contact resistance after the 100 hour immersion experiment for Examples 12-17 was approximately 30-50 [Ω-cm²], and even after the immersion experiment, the contact resistance was comparatively low. The experimental bipolar plate materials obtained in Examples 12-17 maintained a low contact resistance between the separator and the electrode even in an oxidizing environment, and the materials exhibited excellent corrosion resistance.

In Examples 1 to 17, the contact resistance between the bipolar plate and the electrode could be maintained low even in an acidic environment, and excellent corrosion resistance was observed. Furthermore, it was possible to conduct the nitriding treatment by simple processes and low cost processes such as plasma nitriding. Plasma nitriding was used to fabricate bipolar plates for fuel cells that maintain a low contact resistance value even in an acidic environment. Moreover, in Examples 1 to 11, it was verified that bipolar plates having an overlayer of the transition metal nitrides according to the present invention exhibit excellent corrosion resistance, low contact resistance and high electromotive force per unit cell, thereby enabling the formation of a fuel cell stack with high storage capacity and long cycle life.

Various embodiments of the invention have been described. These and other embodiments are within the scope of the following claims.

1. A chemical composition comprising a transition metal nitride having a chemical formula (Fe_{100-x-y-z}CrₓNi_{y}Mo_{z})₄N_{w}, wherein 0.8≦w≦1.7, 19≦x≦30, 11≦y≦19, and 0≦z≦3.

2. The chemical composition of claim 1, wherein the transition metal nitride exhibits a crystalline lattice structure having a face-centered cubic unit cell, wherein a transition metal atom selected from Fe, Cr, Ni or Mo is positioned at each of the unit cell corners and face-centers, and wherein a nitrogen atom is positioned at the center of the unit cell within an octahedral lattice structure formed by the transition metal atoms positioned at the face-centers of the unit cell.

3. A chemical composition comprising a transition metal nitride, wherein the composition of the transition metal nitride is characterized by the relationship 5.9≦{0.01[6(atomic percent Fe)+5(atomic weight percent Cr)+8(atomic weight percent Ni)+5 (atomic weight percent Mo)]}≦6.1, and wherein the transition metal nitride exhibits an atomic ratio of transition metal atoms to nitrogen atoms of from about 4:0.8 to about 4:1.

4. The chemical composition of claim 3, wherein the transition metal nitride exhibits a crystalline lattice structure having a face-centered cubic unit cell, wherein a transition metal atom selected from Fe, Cr, Ni or Mo is positioned at each of the unit cell corners and face-centers, and wherein a nitrogen atom is positioned at the center of the unit cell within an octahedral lattice structure formed by the transition metal atoms positioned at the face-centers of the unit cell.

5. A bipolar plate for a fuel cell, comprising:
a base layer formed of a stainless steel comprising Fe as a major component, Cr, and at least one element selected from Ni or Mo, and
a transition metal nitride layer overlaying the base layer and having the empirical formula M₄N_{w}, wherein M is selected from the group consisting of Fe, Cr, Ni, Mo and combinations thereof, N is nitrogen, and w is from about 0.8 to about 1.7.

6. The bipolar plate of claim 5, wherein the transition metal nitride layer exhibits a crystalline lattice structure having a face-centered cubic unit cell, wherein a transition metal atom selected from Fe, Cr, Ni or Mo is positioned at each of the unit cell corners and face-centers, and wherein a nitrogen atom is positioned at the center of the unit cell within an octahedral lattice structure formed by the transition metal atoms positioned at the face-centers of the unit cell.

7. The bipolar plate of claim 5, wherein the transition metal nitride has the formula (Fe_{100-x-y-z}CrₓNi_{y}Mo_{z})₄N_{w}, wherein 0.8≦w≦1.7, 19≦x≦30, 11≦y≦19, and 0≦z≦3.

8. The bipolar plate of claim 5, wherein the composition of the transition metal nitride is characterized by the relationship 5.9≦{0.01[6(atomic percent Fe)+5(atomic weight percent Cr)+8(atomic weight percent Ni)+5 (atomic weight percent Mo)]}≦6.1.

9. The bipolar plate of claim 5, wherein a surface of the bipolar plate comprises a plurality of channels, and wherein the channels provide a path for at least one of a fuel gas or an oxidant gas fed to a unit fuel cell.

10. A fuel cell assembly, comprising:
a plurality of unit fuel cells arranged in a stack, wherein each unit fuel cell is separated by a bipolar plate, and wherein the bipolar plate comprises:
a base layer of a stainless steel comprising Fe as a major component, Cr, and at least one element selected from Ni or Mo; and
a transition metal nitride layer that overlays the base layer and has the empirical formula M₄N_{w}, wherein M is selected from the group consisting of Fe, Cr, Ni, Mo and combinations thereof, N is nitrogen, and w is from about 0.8 to about 1.7.

11. The fuel cell assembly of claim 10, wherein the transition metal nitride layer exhibits a crystalline lattice structure having a face-centered cubic unit cell, wherein a transition metal atom selected from Fe, Cr, Ni or Mo is positioned at each of the unit cell corners and face-centers, and wherein a nitrogen atom is positioned at the center of the unit cell within an octahedral lattice structure formed by the transition metal atoms positioned at the face-centers of the unit cell.

12. The fuel cell assembly of claim 10, wherein the plurality of unit fuel cells is used to provide power to an electric-powered vehicle.

13. A method of manufacturing a fuel cell bipolar plate, comprising the steps of:
forming a nitrided layer on a surface of a stainless steel material, wherein the stainless steel material comprises Fe as a major component, Cr, and at least one element selected from Ni or Mo; and wherein said nitrided layer has an empirical formula M₄N_{0.8-1.7}, wherein M is selected from the group consisting of Fe, Cr, Ni, Mo and combinations thereof, and N is a nitrogen atom.

14. The method of claim 13, wherein the nitrided layer comprises:
(Fe_{100-x-y-z}CrₓNi_{y}Mo_{z})₄N_{w}, and wherein 0.8≦w≦1.7, 0.19≦x≦30, 11≦y≦19, and 0≦z≦3.

15. The method of claim 14, wherein the nitrided layer exhibits a crystalline lattice structure having a face-centered cubic unit cell, wherein a transition metal atom selected from Fe, Cr, Ni or Mo is positioned at each of the unit cell corners and face-centers, and wherein a nitrogen atom is positioned at the center of the unit cell within an octahedral lattice structure formed by the transition metal atoms positioned at the face-centers of the unit cell.

16. The method of claim 13, wherein the nitrided layer comprises a transition metal nitride characterized by the relationship 5.9≦{0.01[6(atomic percent Fe)+5(atomic weight percent Cr)+8(atomic weight percent Ni)+5 (atomic weight percent Mo)]}≦6.1.

17. The method of claim 13, wherein the nitrided layer is formed by plasma nitriding.

18. The method of claim 17, wherein plasma nitriding comprises applying a negative bias voltage to said stainless steel material in a non-equilibrium plasma formed by passing an electrical discharge through a mixture of nitrogen gas and hydrogen gas at a temperature of about 400° C. to about 500° C.

19. A bipolar plate for a fuel cell produced according to the method of claim 18.

20. A bipolar plate for a fuel cell, comprising:
a base layer formed of a stainless steel comprising Fe as a major component, Cr, and at least one element selected from Ni or Mo, and
a transition metal nitride layer overlaying the base layer and having the empirical formula M₄N_{w}, wherein M is selected from the group consisting of Fe, Cr, Ni and Mo, and w is from about 0.8 to about 1.7.
